(19) United States
(12) Patent Application Publication
(10) Pub. No.: US 2009/0279728 A1
(43) Pub. Date: Nov. 12, 2009

(54) GAME CONTROLLER WITH SPEAKER

(76) Inventor: Kun-Hong HOU, Taipei City (TW)

Correspondence Address: Muncy, Geissler, Olds & Lowe, PLLC, P.O. BOX 1364, FAIRFAX, VA, 22038-1364, US

(21) Appl. No.: 12/195,911

(22) Filed: Aug. 21, 2008

(30) Foreign Application Priority Data
May 12, 2008 (TW) 097117389

(51) Int. Cl. H04R 1/02

(52) U.S. Cl. 381/334

(57) ABSTRACT

A game controller with speaker is disclosed. The game controller is applied in a personal computer or a TV game machine and includes a control command receiving unit, a control unit, a connector terminal and a speaker. The control command receiving unit is used for receiving a game control command and outputting a control command signal. The control unit is coupled to the control command receiving unit used for receiving the control command signal. The connector terminal is coupled to the control unit and the personal computer or the TV game machine for receiving the control command signal and a first audio signal. The speaker is used for receiving and broadcasting the first audio signal.

This Application claims priority of Taiwan Patent Application No. 97117389, filed on May 12, 2008, the entirety of which is incorporated by reference herein.

### BACKGROUND OF THE INVENTION

1. Field of the Invention

The invention relates to a game controller with an audio signal output device, and more particularly to a game controller for driving a game on a personal computer or a TV game machine.

2. Description of the Related Art

Conventionally, when games are played on a personal computer or a TV game machine, a unit similar to a joystick of a video game console is necessary for many games. Buttons on this kind of unit with respect to a corresponding game application are provided for facilitating game driving.

Moreover, for playing games on a personal computer or a TV game machine, a speaker or a headphone is required to be connected to an audio signal output device on the personal computer or the TV game machine for audio signal output. Usually, the audio signal output device is an audio sound card embedded or external to the motherboard. Analog or digital signals for audio output are transmitted to the speaker or the headphone and subsequently broadcasted therethrough.

Therefore, an audio sound card is additionally required for playing games. Further, most output terminals of the audio sound card are in the back of a personal computer case, such that it is inconvenient when switching a speaker or a headphone. Thus, there is a need for solving the aforementioned inconvenience.

### BRIEF SUMMARY OF THE INVENTION

One objective of the invention provides a game controller with a speaker used for playing games on a personal computer or a TV game machine. The game controller comprises: a control command receiving unit for receiving a game control command and outputting the control command signal; a control unit coupled to the control command receiving unit for receiving the control command signal; a connector terminal coupled to the control unit and the personal computer or the TV game machine for receiving the control command signal from the control unit and outputting the control command signal to the personal computer or the TV game machine, and for receiving a first audio signal from the personal computer or the TV game machine and transmitting the first audio signal to the control unit; and a speaker coupled to the control unit for receiving the first audio signal from the control unit and broadcasting the first audio signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of the game controller with a speaker according to a preferred embodiment of the invention; and

FIG. 2 is a block diagram illustrating an audio converter according to a preferred embodiment of the invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

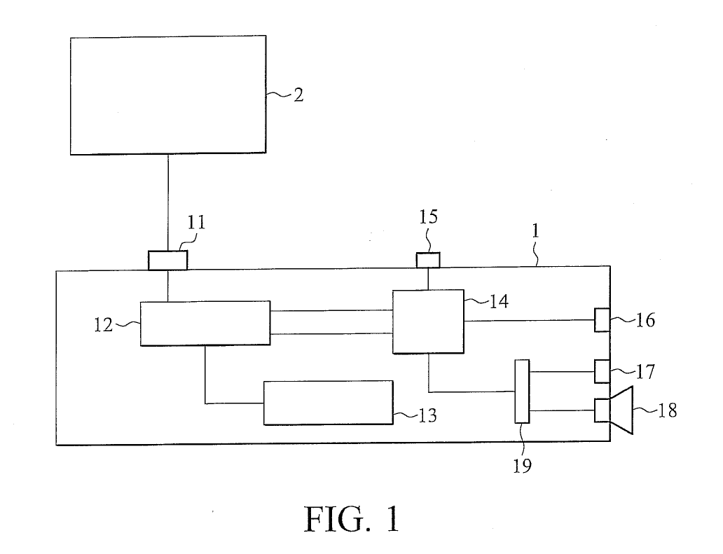

Please refer to FIG. 1. FIG. 1 is a block diagram of the game controller with an audio signal output according to a preferred embodiment of the invention. As shown in FIG. 1, the game controller 1 comprises a connector terminal 11, a control unit 12, a control command receiving unit 13, an audio converter 14, a volume adjusting unit 15, an audio signal input terminal 16, an audio signal output terminal 17 and a speaker 18.

Furthermore, the connector terminal 11 communicates with a personal computer 2 via a universal serial bus (USB), receives a first audio signal via the universal serial bus from the personal computer 2 and transmits the first audio signal to the control unit 12, where the first audio signal is a digital signal received and transmitted by the control unit 12 to the audio converter 14.

The audio converter 14 is simultaneously coupled to the volume adjusting unit 15, the audio signal input terminal 16, the audio signal output terminal 17 and the speaker 18, where a portion of the volume adjusting unit 15 is disposed outside of the game controller 1 for manually adjusting the volume adjusting unit 15. The audio signal input terminal 16 comprises a connector for plugging in a microphone (not shown) and transmits a second audio signal to the audio converter 14 via an audio recording unit. Similarly, the audio signal output terminal 17 comprises a connector for coupling to a headphone or an external speaker, etc (not shown). The first audio signal from the audio converter 14 is received by the audio signal output terminal 17 and then transmitted to an external headphone or a speaker, and so on.

Moreover, the speaker 18 coupled to the audio converter 14 is provided for receiving the first audio signal outputted from the audio converter 14 and further broadcasting the first audio signal.

In addition, the volume adjusting unit 15 is provided for adjusting the volume of the first audio signal so as to determine the volume of the first audio signal and the speaker 18 when the audio signal output terminal 17 transmits the first audio signal to the external headphone or the speaker.

Also, the speaker 18 and the audio signal output terminal 17 are provided for receiving the first audio signal from the audio converter 14. Therefore, a selector 19 among the speaker 18, the audio signal output terminal 17 and the audio converter 14 is further provided, wherein the selector 19 coupled to the audio converter 14 receives the first audio signal from the audio converter 14 and outputs the speaker 18 or the audio signal output terminal 17. The selector 19 chooses the first audio signal to be outputted to the audio signal output terminal 17 when an external headphone or a speaker is connected to the audio signal output terminal 17, or to be outputted to the speaker 18 when neither of an external headphone or speaker is connected to the audio signal output terminal 17.

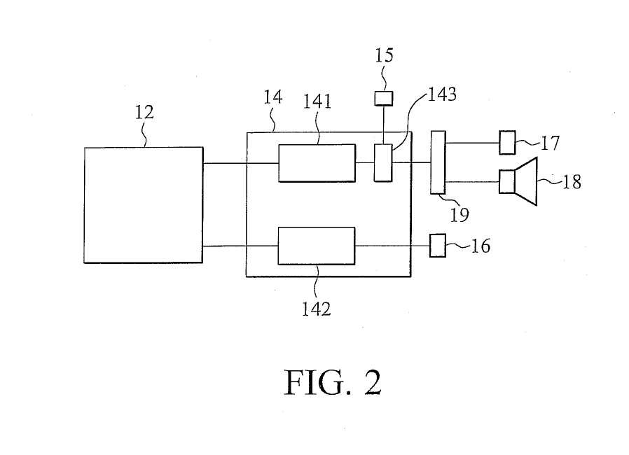

Please refer to FIG. 2. FIG. 2 is a block diagram illustrating an audio converter according to a preferred embodiment of the invention. The audio converter 14 comprises a digital/analog converter 141, an analog/digital conversion 142 and an amplifier 143, wherein the digital/analog converter 141 is coupled to the control unit 12 and the amplifier 143 for converting the digital format of the first audio signal from the control unit 12 into an analog format to be transmitted to the amplifier 143. The amplifier 143 coupled to the volume adjusting unit 15 and the selector 19 determines an amplifying ratio of the first audio signal according to the volume adjusting unit 15 and then outputs it to the selector 19.

The analog/digital converter 142 is coupled to the control unit 12 and the audio signal input terminal 16 for receiving the second audio input signal from the audio signal input terminal 16, and converting the analog format of the second audio signal into a digital format to be transmitted to the control unit 12.

As shown in FIG. 1, the game controller 1 further comprises a plurality of controlling buttons (not shown), wherein the plurality of controlling buttons generates a game control command by pressing or vibrating manually. The control command receiving unit 13 is used for receiving the game control command and outputting a control command signal to the control unit 12 according to the game control command. The control unit 12 outputs the control command signal to the personal computer 2 via the output terminal 11 so as to drive the game.

As mentioned above, it is necessary for the control unit 12 to simultaneously receive the first audio signal from the personal computer 2, the control command signal from the control command receiving unit 13 and the second audio signal from the audio signal input terminal 16. Then, the control unit 12 simultaneously transmits the first audio signal to the audio signal output terminal 17 or the speaker 18 as well as the control command signal and the second audio signal to the personal computer 2 via the connector terminal 11 so as to drive the game. Therefore, the control unit 12 is required to simultaneously process bi-directional communication of three different signals

In addition, the selector 19 is a multiplexer, connectors of the audio signal input terminal 17 and the audio signal input terminal 16 are common audio connectors and the personal computer 2 may be replaced by a game machine, but is not limited thereto.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A game controller with a speaker for driving games on a personal computer or a TV game machine comprising:
a control command receiving unit for receiving a game control command and transmitting a control command signal;
a control unit coupled to the control command receiving unit for receiving the control command signal;
a connector terminal coupled to the control unit and the personal computer or the TV game machine for receiving the control command signal from the control unit and transmitting the control command signal to the personal computer or the TV game machine, and receiving a first audio signal from the personal computer or the TV game machine and transmitting the first audio signal to the control unit; and
a speaker coupled to the control unit for receiving the first audio signal from the control unit and broadcasting the first audio signal.

2. The game controller with the speaker according to claim 1, wherein the connector terminal communicates with the personal computer via a universal serial bus (USB).

3. The game controller with the speaker according to claim 1, further comprising a plurality of controlling buttons, wherein the plurality of controlling buttons are pressed or vibrated manually for generating the game control command.

4. The game controller with the speaker according to claim 1, further comprising an audio converter coupled between the speaker and the control unit, wherein the audio converter is provided for receiving the first audio signal from the control unit and converting the first audio signal from a digital format into an analog format for output to the speaker.

5. The game controller with the speaker according to claim 4, further comprising a volume adjusting unit coupled to the audio converter for adjusting the volume of the speaker by manually controlling the volume adjusting unit.

6. The game controller with the speaker according to claim 4, further comprising an audio signal input terminal and an audio signal output terminal respectively coupled to the audio converter, wherein the audio signal input terminal is used for inputting a second audio signal into the audio converter, and the audio signal output terminal is used for receiving the first audio signal from the audio converter.

7. The game controller with the speaker according to claim 6, wherein the audio converter comprises a digital/analog converter for processing the second audio signal inputted from the audio signal input terminal and an analog/digital converter for processing the first audio signal inputted from the control unit.

8. The game controller with the speaker according to claim 4, further comprising a selector coupled between the audio converter, the audio signal output terminal and the speaker for determining whether the first audio signal is outputted to the speaker or the audio signal output terminal according to an external broadcasting device connected to the audio signal output terminal.
